(19) United States
(12) Patent Application Publication
(10) Pub. No.: US 2017/0051725 A1
(43) Pub. Date: Feb. 23, 2017

(54) METHOD AND APPARATUS FOR DIAGNOSING BLADES OF WIND TURBINE

(71) Applicant: NATIONAL TAIWAN UNIVERSITY, Taipei (TW)

(72) Inventors: Chao-Nan WANG, Taipei (TW); Jing-Fa TSAI, Taipei (TW); I-Cheng CHEN, Taipei (TW); Yao-Chi TANG, Taipei (TW); Jeng-Yu CHIN, Taipei (TW)

(21) Appl. No.: 15/202,486

(22) Filed: Jul. 5, 2016

Related U.S. Application Data
(60) Provisional application No. 62/208,021, filed on Aug. 21, 2015.

(30) Foreign Application Priority Data
Feb. 4, 2016 (TW) 105103697

(51) Int. Cl. F03D 17/00; F03D 1/06

(52) U.S. Cl. CPC F03D 17/00; F03D 1/0675; F05B 2260/80

(57) ABSTRACT

A method for diagnosing blades of a wind turbine is provided. The method includes steps of acquiring, via a microphone, an operation sound of the wind turbine when the wind turbine is under operation; transforming the operation sound into a time-frequency spectrum; integrating the time-frequency spectrum over time to generate a marginal spectrum; determining whether any blade of the wind turbine is damaged according to the marginal spectrum and a reference curve.

### CROSS REFERENCE TO RELATED APPLICATIONS

This application claims the benefit of U.S. Provisional Application No. 62/208,021 filed Aug. 21, 2015, the entirety of which is incorporated by reference herein.

This Application claims priority of Taiwan Patent Application No. 105103697, filed on Feb. 4, 2016, the entirety of which is incorporated by reference herein.

### BACKGROUND OF THE INVENTION

Field of the Invention

The present invention relates to a method for diagnosing blades of a wind turbine, and in particular relates to a method for diagnosing blades of a wind turbine when the wind turbine is operating.

Description of the Related Art

Wind energy is the energy generated from air flow, and the wind power is generated by transforming the wind energy into electric energy via specific power generation device. The wind energy is clean, renewable and plentiful, and the wind power does not produce greenhouse gas during wind power generation. The wind power becomes a new choice as an alternative power generation using fossil fuels.

The wind power generation device comprises a wind turbine blade mechanism with a plurality wind turbine blades, a transmission mechanism and a power generation device. When the wind turbine blade mechanism is driven and rotated by the wind energy, mechanical energy is generated and transmitted to the power generation device via the transmission mechanism, and the power generation device transforms the mechanical energy into electric energy by electromagnetic induction principle. The generated electric energy is stored in a battery or transmitted to a power grid.

The wind turbine blades are typically formed of composite materials, which are capable of withstanding the stress to which the blade will be subjected during operation of the turbine. In some conditions, defects may occur during manufacture of the blades. Alternatively, in some cases defects may arise as a result of excessive strain or loading on the blade during operation of the turbine. In another condition, the defects are generated because of blade fatigue during long-term operation. In other condition, the defects are generated when objects, such as sands, hits the blades during operation.

Generally speaking, the cost for setting up a wind turbine is extremely high, and when the wind turbine is set up, it is not easy to disassemble the wind turbine to check the blades of wind turbine. The current monitoring apparatus for the wind turbine monitors the rotation speed of the wind turbine, the wind speed and the generation power capacity. Once any one of the described three parameters is abnormal, the wind turbine is usually serious damaged, and needs to shut down for maintenance. There is no dedicated apparatus for monitoring the status of the blades of the wind turbine. The traditional testing method for checking the status of the blades has to disassemble the wind turbine, and checks the status of blades by ultrasonic detector. This is inconvenient and wastes time.

### BRIEF SUMMARY OF THE INVENTION

The present invention provides a method for diagnosing blades of a wind turbine, and more particularly to a method for diagnosing blades of a wind turbine when the wind turbine is operating.

An embodiment of the invention provides a method for diagnosing blades of a wind turbine. The method includes steps of acquiring, via a microphone, an operation sound of the wind turbine when the wind turbine is under operation; transforming the operation sound into a time-frequency spectrum; integrating the time-frequency spectrum over time to generate a marginal spectrum; determining whether any blade of the wind turbine is damaged according to the marginal spectrum and a reference curve.

Another embodiment of the invention provides a monitoring apparatus for monitoring blades of wind turbine. The monitoring apparatus comprises a microphone to acquire an operation sound of the wind turbine when the wind turbine is under operation; a diagnosing device to transform the operation sound into a time-frequency spectrum, integrate the time-frequency spectrum over time to generate a marginal spectrum, and determine whether any blade of the wind turbine is damaged according to the marginal spectrum and a reference curve; and a diagnosis output device to output a diagnosis result of the diagnosing device.

A detailed description is given in the following embodiments with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention can be more fully understood by reading the subsequent detailed description and examples with references made to the accompanying drawings, wherein:

FIG. 1 shows a comparison diagram for a normal wind turbine and a wind turbine with damaged blade in time domain and time-frequency domain.

FIG. 2A is a time-frequency spectrum diagram of a normal wind turbine.

FIG. 2B is a time-frequency spectrum diagram of a wind turbine with damaged blades.

FIG. 3 is a flow chart of a method for diagnosing blades of a wind turbine according to an embodiment of the invention.

FIG. 4 is a flow chart of a reference curve generation method of a wind turbine according to an embodiment of the invention.

FIG. 5 is a schematic diagram showing a reference curve and a marginal spectrum.

FIG. 6 is a schematic diagram showing a variation of an index of a normal wind turbine during a predetermined period.

FIG. 7 is a schematic diagram showing a variation of an index of a wind turbine to be tested during a predetermined period.

FIG. 8 is a flow chart of a method for diagnosing blades of a wind turbine according to another embodiment of the invention.

FIG. 9 is a flow chart of a method for diagnosing blades of a wind turbine according to another embodiment of the invention.

FIG. 10 is a schematic diagram of an apparatus for monitoring blades of a wind turbine according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The major parts of a wind turbine are wind turbine blades. The number of the wind turbine blades is three in most cases, however the proposed damage detection method can be applied to any number of wind turbine blades of a wind turbine. The conventional damage detection method needs to stop the wind turbine, but the proposed damage detection method can be applied to the wind turbine under operation.

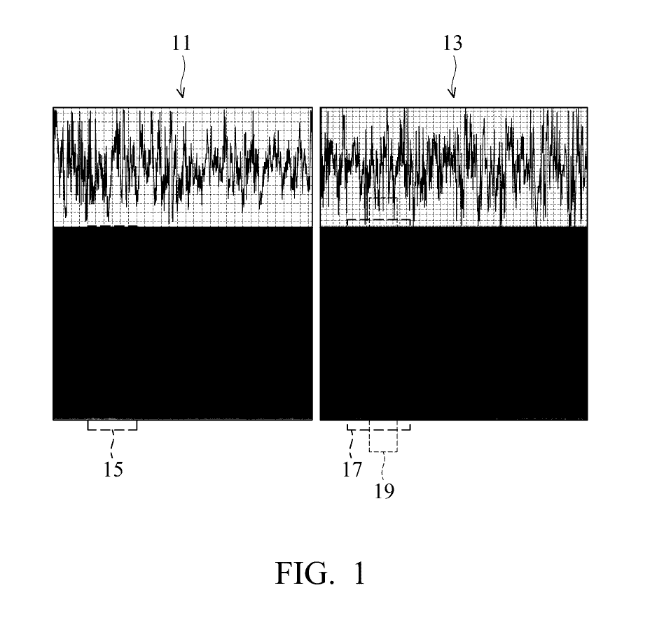

FIG. 1 shows a comparison diagram for a normal wind turbine and a wind turbine with damaged blade. The left side 11 shows an operational sound of the wind turbine with damaged blade in time domain (black curve) and a time-frequency domain (red curve). The right side 13 shows an operational sound of the normal wind turbine in time domain (black curve) and a time-frequency domain (red curve). It is not easy to find difference in time domain, but it is easier to find difference in time-frequency domain. In the square 15 of the time-frequency spectrum, we can find three peaks, but in the square 17 of the time-frequency spectrum, only indistinct peaks are observed. The square 19 indicates an almost invisible peak. Thus, by observing the time-frequency spectrum of the wind turbine, it is possible to find whether the blade of the wind turbine is damaged. The present application provides a valuable damage detection method based on the phenomenon.

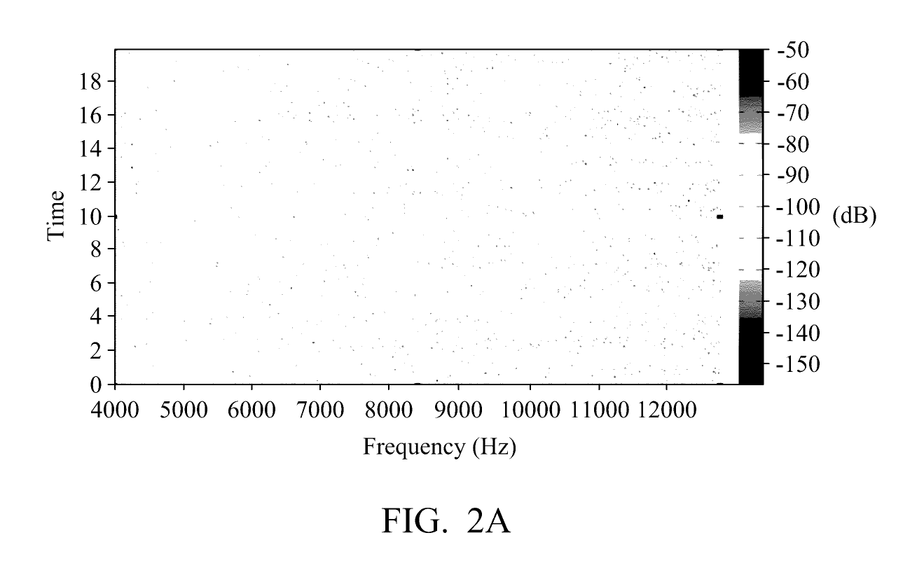

In general case, the damaged blade may cause a high frequency noise ranged from 4000 Hz to 12800 Hz. Thus, we can also focus on the high frequency part of the time-frequency spectrum. Pleases refer to FIG. 2A and FIG. 2B. In FIG. 2A and FIG. 2B, the color corresponds to the magnitude of energy of corresponding frequency. If the color is close to the red color, it means the magnitude of energy of corresponding frequency is large. If the color is close to the blue color, it means the magnitude of energy of corresponding frequency is small. FIG. 2A is a time-frequency spectrum diagram of a normal wind turbine. FIG. 2B is a time-frequency spectrum diagram of a wind turbine with damaged blades. In FIG. 2A, the energy does not increase obviously in the time-frequency spectrum. However, in FIG. 2B, such as shown in red frame 21, the energy is extremely large, and it means that the blade of the wind turbine may be damaged. Therefore, we can determine whether any blade of the wind turbine is damaged according to the time-frequency spectrum of the wind turbine.

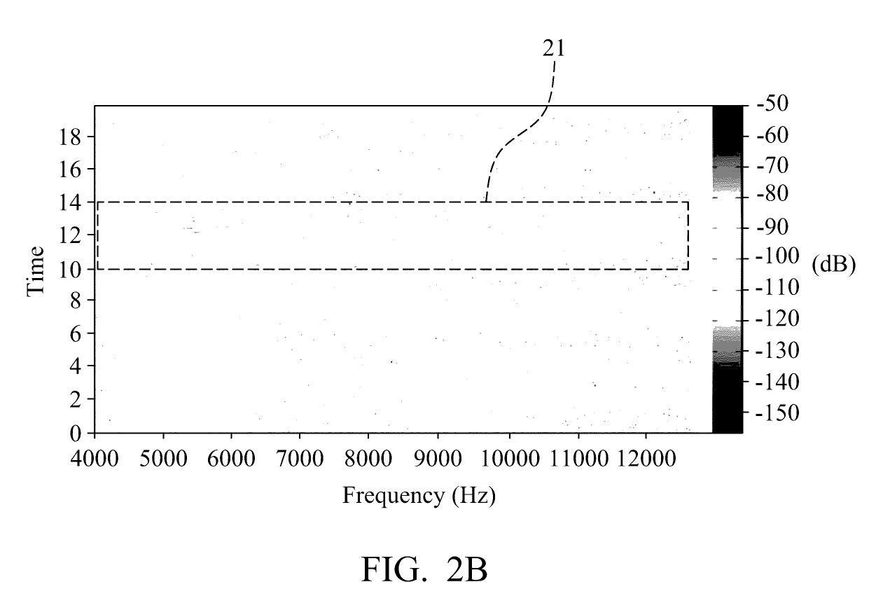

FIG. 3 is a flow chart of a method for diagnosing blades of a wind turbine according to an embodiment of the invention. In step S31, an operation sound is acquired by a microphone when the wind turbine is operating. In step S32, an electronic device applies a short-time Fourier transform to the operation sound to generate a time-frequency spectrum corresponding to the operation sound. In this embodiment, the short-time Fourier transform is illustrated, but the time-frequency spectrum can be generated by other method, such as the wavelet transform or Hilbert-Huang transform.

In step S33, a processor or an electronic device integrates the time-frequency spectrum over time to generate a marginal spectrum. The marginal spectrum is a magnitude versus frequency diagram. The marginal spectrum provides a total amplitude or energy contributed by each frequency. In step S34, the processor or the electronic device determines whether any blade of the wind turbine is damaged according to the marginal spectrum and a reference curve. In one embodiment, the processor or the electronic device estimates an index value according to the marginal spectrum and the reference, and determines whether any blade of the wind turbine is damaged according to the index value.

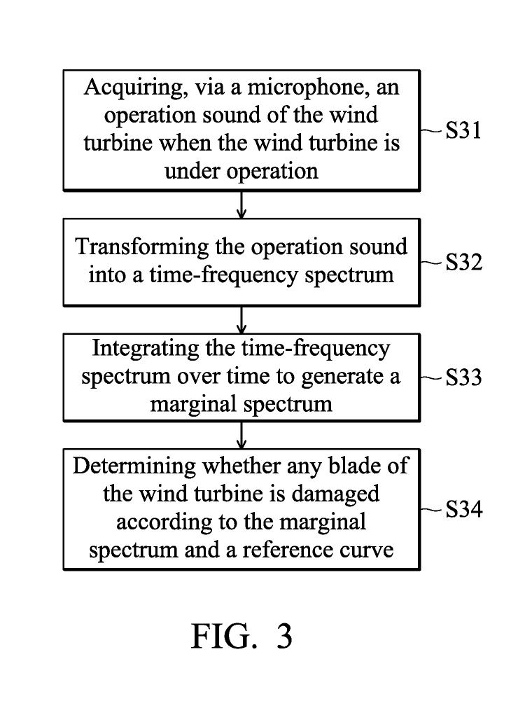

In the flow chart of FIG. 3, the reference curve is generated according to the normal operation sound when the wind turbine operates normally. In general cases, the sound generated by the wind turbine varies according to the position the wind turbine is. In other words, each wind turbine has its specific reference curve. In another embodiment, the reference curve is updated periodicity. The generation of the reference curve can be referred to FIG. 4.

FIG. 4 is a flow chart of a reference curve generation method of a wind turbine according to an embodiment of the invention. In step S41, a normal operation sound is acquired by a microphone when the wind turbine is operating. In this embodiment, the normal operation sound is the sound generated by the wind turbine during operation of the wind turbine when there is no damage on the blade of the wind turbine. In general cases, the normal operation sound can be measured when the wind turbine is set up and normally operates. In step S42, an electronic device applies a short-time Fourier transform on the normal operation sound to transform the normal operation sound into an initial time-frequency spectrum. In this embodiment, the short-time Fourier transform is illustrated, but the time-frequency spectrum can be generated by other method, such as the wavelet transform or Hilbert-Huang transform.

Then, in step S43, a processor or an electronic device integrates the initial time-frequency spectrum over time to generate an initial marginal spectrum. The marginal spectrum is a magnitude versus frequency diagram. The marginal spectrum provides a total amplitude or energy contributed by each frequency. In other words, the marginal spectrum comprises a plurality of data, and each data contains a frequency value and a magnitude value, wherein the magnitude value can be energy or other similar parameter. In step S44, the processor or the electronic device estimates a fitting curve to be the reference curve of the wind turbine according to the plurality of data in the marginal spectrum. In one embodiment, the fitting curve is estimated by method of least-square approximations approach.

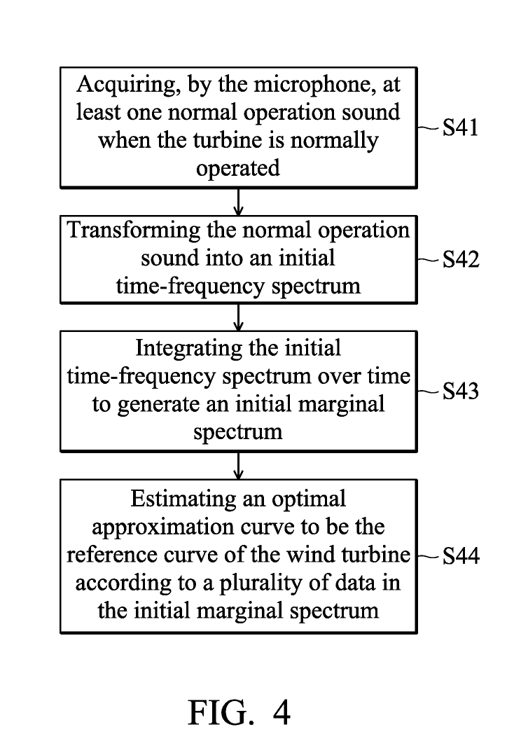

For further illustration to the reference curve and the marginal spectrum, please refer to FIG. 5. FIG. 5 is a schematic diagram showing a reference curve and a marginal spectrum. FIG. 5 shows an initial marginal spectrum (labeled by symbol ♦ in FIG. 5), which is used to generate the reference curve, and a marginal spectrum under test (labeled by symbol circle in FIG. 5), which is generated according to a plurality of test data when executing a blade diagnosis method.

In FIG. 5, the reference curve 51 is generated according to a plurality of initial data. In this embodiment, an index value is estimated according to the reference curve, the initial marginal spectrum and the marginal spectrum under test to determine whether any blade of the wind turbine is damaged. The index value is calculated by following equation:

$$index = \frac{A - B}{B} ,$$

wherein a first sum of squares of deviations A is the sum of square of difference between each fault condition data and each corresponding data on the fitting curve, and a second sum of squares of deviations B is the sum of square of difference between each normal condition data and each corresponding data on the fitting curve.

In one embodiment, when the reference curve 51 is determined, the second sum of squares of deviations B is also determined simultaneously. In other words, the first sum of squares of deviations A and the second sum of squares of deviations B can be calculated at different time point.

Once the index is greater than a threshold, it is determined that the wind turbine under test has at least one damaged blade. However, it may not be accurate to determine whether any blade of the wind turbine is damaged according to the index calculated at one single time point. Thus, we can set an index threshold according to a plurality of indexes during a predetermine time period, and determines whether any blade of the wind turbine is damaged according to the index threshold and index generated according to the wind turbine under test.

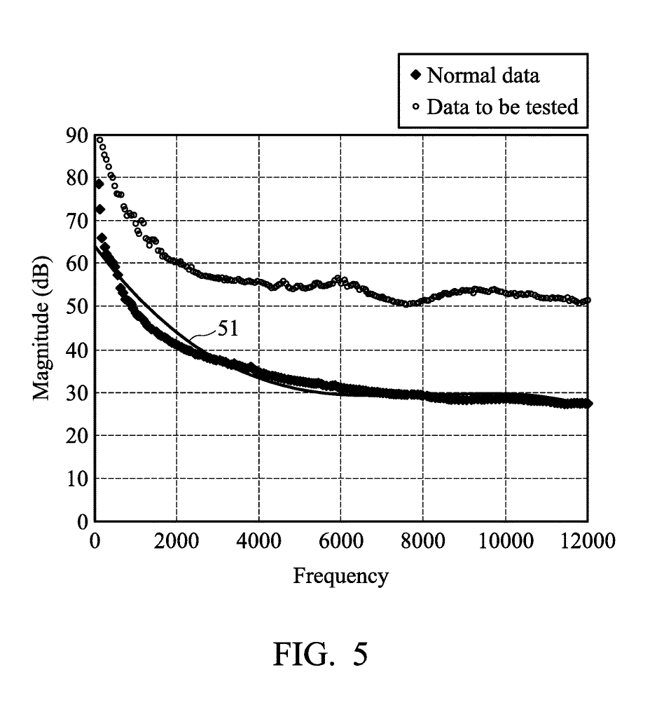

FIG. 6 is a schematic diagram showing a variation of an index of a normal wind turbine during a predetermined period. In FIG. 6, the index variation of a normal wind turbine during a predetermined time period, such as 20 seconds, is not obvious. Thus, we can set an index threshold, such as shown in FIG. 6, according to the index variation in FIG. 6.

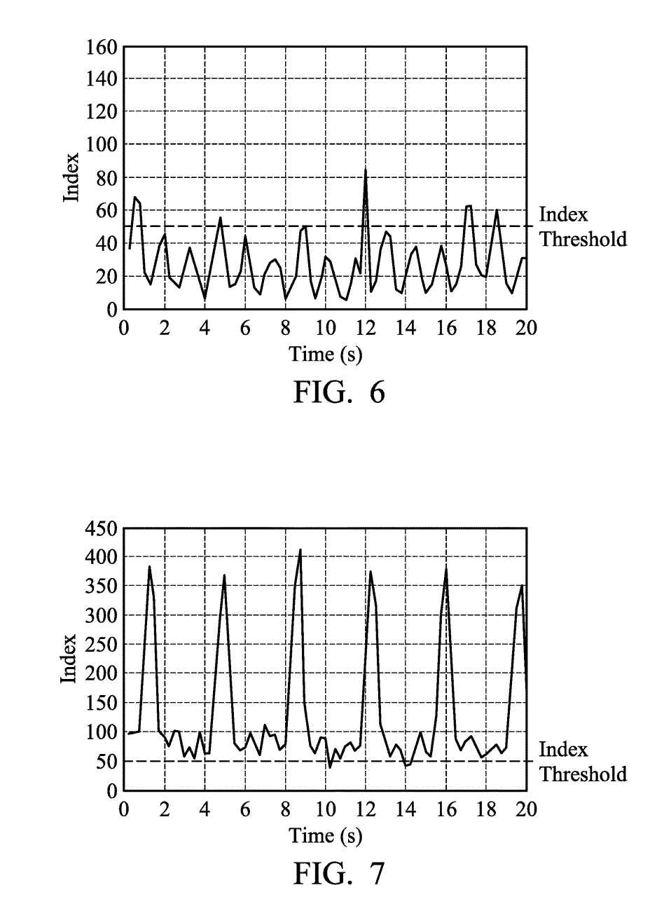

FIG. 7 is a schematic diagram showing a variation of an index of a wind turbine to be tested during a predetermined period. Obviously, most index values shown in FIG. 7 excessed the index threshold, and there is obvious abnormal index value in FIG. 7, such as the index value at 9^{th} second. Therefore, it can be determined, by an electronic device, that the blade of the wind turbine under test in FIG. 7 is damaged according to the index threshold of FIG. 6.

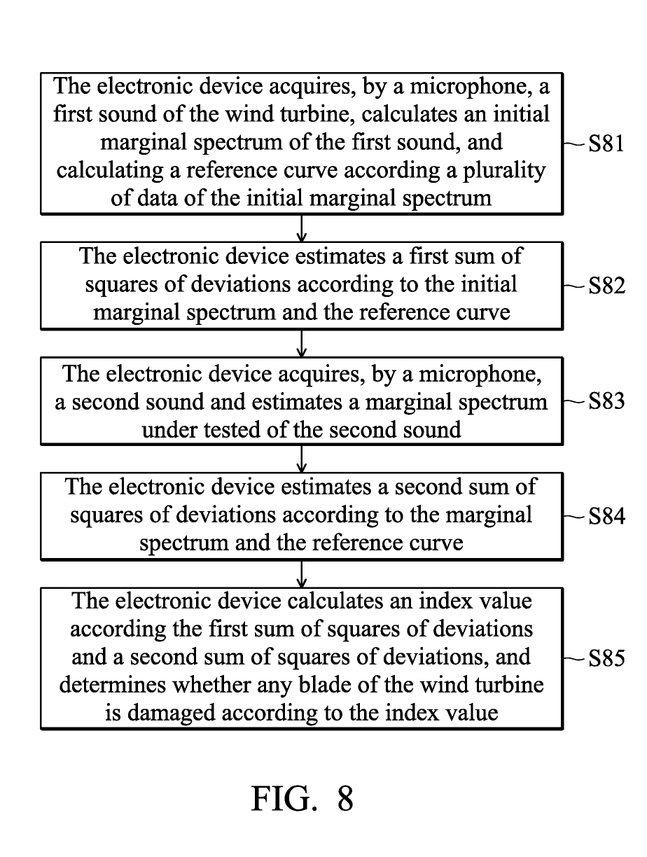

FIG. 8 is a flow chart of a method for diagnosing blades of a wind turbine according to another embodiment of the invention. The method is executed by an electronic device. The method for diagnosing blades of a wind turbine comprising steps of:

Step S81: The electronic device acquires, by a microphone, a first sound of the wind turbine, calculates an initial marginal spectrum of the first sound, and calculating a reference curve according a plurality of data of the initial marginal spectrum.

Step S82: The electronic device estimates a first sum of squares of deviations according to the initial marginal spectrum and the reference curve.

Step S83: The electronic device acquires, by a microphone, a second sound and estimates a marginal spectrum under tested of the second sound.

Step S84: The electronic device estimates a second sum of squares of deviations according to the marginal spectrum and the reference curve.

Step S85: The electronic device calculates an index value according the first sum of squares of deviations and a second sum of squares of deviations, and determines whether any blade of the wind turbine is damaged according to the index value.

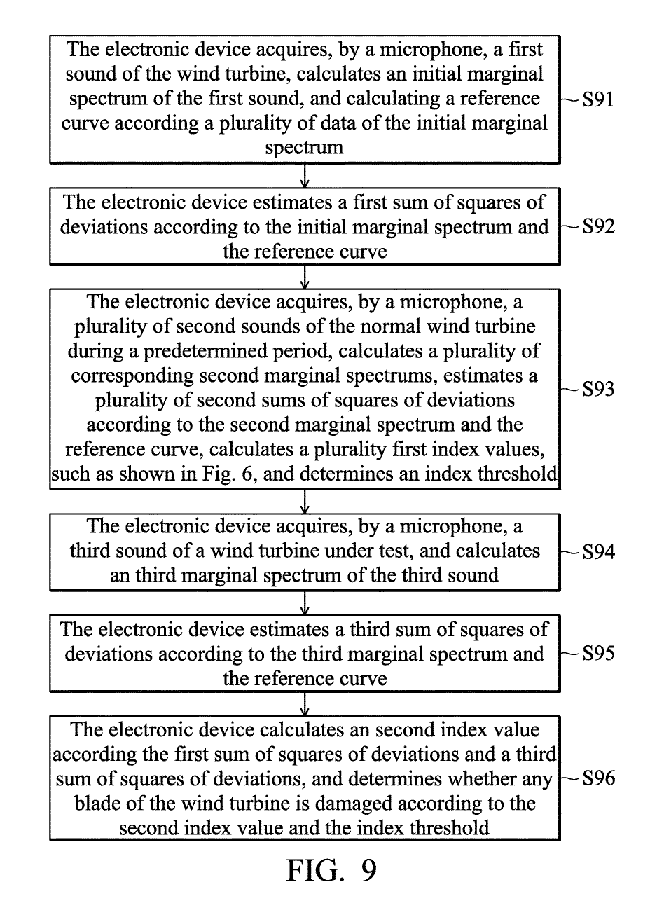

FIG. 9 is a flow chart of a method for diagnosing blades of a wind turbine according to another embodiment of the invention. The method is executed by an electronic device. The method for diagnosing blades of a wind turbine comprising steps of:

Step S91: The electronic device acquires, by a microphone, a first sound of the wind turbine, calculates an initial marginal spectrum of the first sound, and calculating a reference curve according a plurality of data of the initial marginal spectrum.

Step S92: The electronic device estimates a first sum of squares of deviations according to the initial marginal spectrum and the reference curve.

Step S93: The electronic device acquires, by a microphone, a plurality of second sounds of the normal wind turbine during a predetermined period, calculates a plurality of corresponding second marginal spectrums, estimates a plurality of second sums of squares of deviations according to the second marginal spectrum and the reference curve, calculates a plurality first index values, such as shown in FIG. 6, and determines an index threshold.

Step S94: The electronic device acquires, by a microphone, a third sound of a wind turbine under test, and calculates a third marginal spectrum of the third sound.

Step S95: The electronic device estimates a third sum of squares of deviations according to the third marginal spectrum and the reference curve.

Step S96: The electronic device calculates a second index value according the first sum of squares of deviations and a third sum of squares of deviations, and determines whether any blade of the wind turbine is damaged according to the second index value and the index threshold.

In another embodiment, the electronic acquires a plurality of continuous sound signals during a plurality of continuous time period, and calculates a plurality of second index values, such as shown in FIG. 7. The electronic device determines whether any blade of the wind turbine is damaged according to the variation of index value during a predetermined period. Furthermore, the electronic device acquires a relation between the blades and the index value by a synchronization device, and determines which blade is damaged according to the index variation shown in FIG. 7. For example, in FIG. 7, the blades corresponding to 1^{st} second and 5^{th} second are damaged.

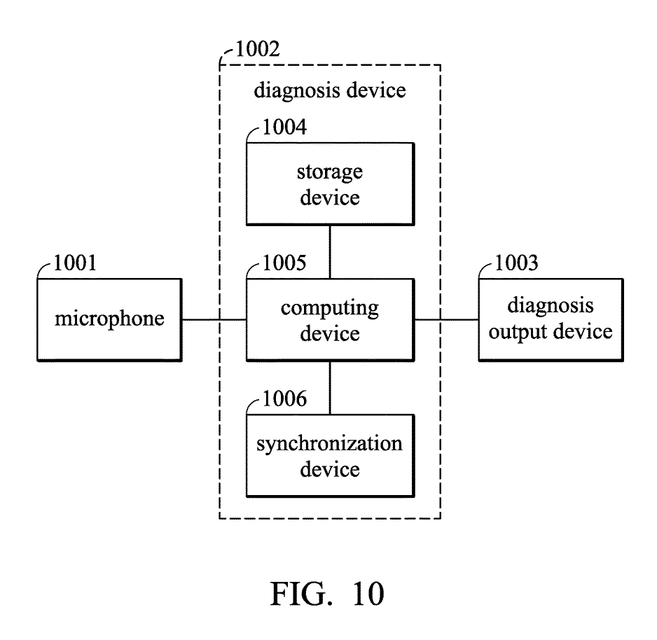

FIG. 10 is a schematic diagram of an apparatus for monitoring blades of a wind turbine according to an embodiment of the invention. The blade monitoring apparatus comprises a microphone 1001, a diagnosis device 1002, and a diagnosis output device 1003. The diagnosis device 1002 acquires an operation sound of the wind turbine via the microphone 1001 when the wind turbine is under operation. When the computing device 1005 receives the operation sound, the computing device 1005 transforms the operation sound into a marginal spectrum under test. The computing device 1005 generates the marginal spectrum according to steps S31˜S33 in FIG. 3. Then, the computing device 1005 accesses the storage device 1004 to acquire a reference curve, and determines whether the blade of wind turbine is damaged according to the reference curve and the marginal spectrum under test. The detail of the method for diagnosing blades of a wind turbine can refer to descriptions of FIG. 5˜FIG. 9. In one embodiment, the computing device 1005 is a processor or a controller to execute a blade diagnosing method, such as described in FIGS. 8˜9.

In this embodiment, the storage device 1004 stores the reference curve provided by manufacturer of the wind turbine. In another embodiment, the reference curve is generated by the computing device 1005 when the wind turbine is set up and operates normally.

In this embodiment, the diagnosis device 1002 further comprises a synchronization device 1006 (unnecessarily means in this embodiment) to synchronize the blades and data generated by the computing device 1005. As shown in FIG. 7, the synchronization device 1006 synchronizes index value and blades to know which blade is damaged. For example, the blade corresponding to the blade at 5^{th} second in FIG. 7 is determined as damaged.

The diagnosis output device 1003 outputs a diagnosis result of the diagnosing device 1002 to let the user know whether any one of blades is damaged, and which blade is damaged. In another embodiment, the diagnosis output device 1003 has an input device, and the user can input control signals to the diagnosing device 1002 via the input device, such as information showed in FIGS. 5˜7.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for diagnosing blades of a wind turbine, comprising:
acquiring, via a microphone, an operation sound of the wind turbine when the wind turbine is under operation;
transforming the operation sound into a time-frequency spectrum;
integrating the time-frequency spectrum over time to generate a marginal spectrum; and
determining whether any blade of the wind turbine is damaged according to the marginal spectrum and a reference curve.

2. The method as claimed in claim 1, wherein the reference curve is provided by the manufacture.

3. The method as claimed in claim 1, wherein the reference curve is generated by following steps:
acquiring, by the microphone, at least one normal operation sound when the turbine is normally operating;
transforming the normal operation sound into an initial time-frequency spectrum;
integrating the initial time-frequency spectrum over time to generate an initial marginal spectrum; and
estimating an optimal approximation curve to be the reference curve of the wind turbine according to a plurality of data in the initial marginal spectrum.

4. The method as claimed in claim 3, wherein the step of determining whether any blade of the wind turbine is damaged further comprises:
estimating a first sum of squares of deviations according to the initial marginal spectrum and the reference curve;
estimating a second sum of squares of deviations according to the marginal spectrum and the reference curve;
calculating an index according to the first sum of squares of deviations and the second sum of squares of deviations; and
determining whether any blade of the wind turbine is damaged according to the index.

5. The method as claimed in claim 4, further comprising:
estimating an index threshold according to a plurality of normal sounds when the wind turbine is normally operating; and
when the index is greater than the index threshold, the blade of the wind turbine is determined as being damaged.

6. A monitoring apparatus for monitor blades of wind turbine, comprising:
a microphone to acquire an operation sound of the wind turbine when the wind turbine is under operation;
a diagnosing device to transform the operation sound into a time-frequency spectrum, integrate the time-frequency spectrum over time to generate a marginal spectrum, and determine whether any blade of the wind turbine is damaged according to the marginal spectrum and a reference curve; and
a diagnosis output device to output a diagnosis result of the diagnosing device.

7. The monitoring apparatus as claimed in claim 6, further comprising a storage medium to store the reference curve.

8. The monitoring apparatus as claimed in claim 6, wherein the reference curve is generated by following steps:
acquiring, by the microphone, at least one normal operation sound when the turbine is normally operating;
transforming the normal operation sound into an initial time-frequency spectrum;
integrating the initial time-frequency spectrum over time to generate an initial marginal spectrum; and
estimating an optimal approximation curve to be the reference curve of the wind turbine according to a plurality of data in the initial marginal spectrum.

9. The monitoring apparatus as claimed in claim 6, wherein the diagnosing device determines whether any blade of the wind turbine is damaged by following steps:
estimating a first sum of squares of deviations according to the initial marginal spectrum and the reference curve;
estimating a second sum of squares of deviations according to the marginal spectrum and the reference curve;
calculating an index according to the first sum of squares of deviations and the second sum of squares of deviations; and
determining whether any blade of the wind turbine is damaged according to the index.

10. The monitoring apparatus as claimed in claim 9, further comprising steps of:
estimating an index threshold according to a plurality of normal sounds when the wind turbine is normally operating; and
when the index is greater than the index threshold, the blade of the wind turbine is determined as being damaged.
